(19) United States
(12) Patent Application Publication
(10) Pub. No.: US 2007/0081452 A1
(43) Pub. Date: Apr. 12, 2007

(54) Access port centralized management

(76) Inventor: Edward Walter, Boerne, TX (US)

Correspondence Address: PAUL S MADAN;MADAN, MOSSMAN & SRIRAM, PC, 2603 AUGUSTA, SUITE 700, HOUSTON, TX, 77057-1130, US

(21) Appl. No.: 11/244,557

(22) Filed: Oct. 6, 2005

(51) Int. Cl. H04L 12/26; H04Q 7/24; H04L 12/56

(52) U.S. Cl. 370/229; 370/389; 370/338

(57) ABSTRACT

The present invention provides a system, method and apparatus for managing a wireless network in conjunction with an Ethernet switch comprising at least one SIP-aware application, an SIP-aware Access Port, and an SIP-aware management device for managing wireless network signals by providing out-of-band SIP signals to the SIP-aware Access Port. The device may comprise a program for load balancing SIP-aware applications and/or a port for monitoring all traffic across all ports. The invention provides for detection of rogue access ports, for the monitoring of RF link quality, Access Port availability and metrics for Quality of Service.

### 1. FIELD OF THE INVENTION

The present invention relates in general to the field of providing management to wireless access ports.

### 2. DESCRIPTION OF THE RELATED ART

Wireless Access Ports are a second generation local area network (LAN) technology that is replacing traditional access points. Features, functionality, security and management may all be combined in one (wireless) switch. Access ports may be less expensive to implement than access points for deploying, implementing and managing a wireless LAN, while potentially increasing features, functionality and security.

Wireless LAN (WLAN) solutions, especially for individual access points/ports, are often incompatible across vendor devices and software. Traditional WLAN solutions distribute all traffic handling, RF control, security, and mobility functions to the access point itself. However, this architecture limits visibility of wireless traffic to individual access points. Therefore, individual access points often must be individually managed, increasing resource requirements. Attacks on the network or access points and interference are not easily detectable. There may be no central points of enforcement for security across layers 1 to 3. Individual access points are largely unable to detect denial of service (DoS) attacks across a wireless network. If a system cannot correlate or predict activity across a network or subnetwork, the ability to optimize distributed applications and to perform load balancing is limited. Mobility among access points may be problematic. Security for a network may be potentially compromised if only one individual access point is breached physically by network attack. This invention addresses these needs.

### SUMMARY OF THE INVENTION

The present invention provides a method, system and apparatus for managing wireless network Access Ports. The present invention provides a system, method and apparatus for managing a wireless network comprising an Ethernet switch, a least one SIP-aware application, an SIP-aware Access Port, and an SIP-aware management device for managing wireless network signals by providing out-of-band SIP signals to the SIP-aware Access Port. The device may comprise a program for load balancing SIP-aware applications and/or a port for monitoring all traffic across all ports. The invention provides for detection of rogue access ports, for the monitoring of RF link quality, Access Port availability and metrics for Quality of Service.

The invention provides a computer readable medium containing instructions that when executed by a computer perform a computerized method for managing out-of-bandwidth aware applications on a wireless network using an Access Port management appliance associated with an Ethernet switch. Out of bandwidth communications may use SIP communication protocol. At least one SIP-aware Access Port and at least one SIP-aware application are identified in the wireless network to receive an SIP message. A route is then determined for Real-time Transport Protocol streams. The Access Port management appliance monitors the SIP-aware application and may perform load balancing over one or a plurality of Access Ports. Monitoring Access Ports includes measuring availability, RF link quality and Quality of Service indicators. Authentication for applications and devices to a network may be via SIP or other out-of-bandwidth messages, and intrusion detection of rogue access ports is also provided.

The present invention provides a system for managing a wireless network comprising an Ethernet switch, an SIP-aware application, an SIP-aware Access Port and an SIP-aware Access Port management device associated with the Ethernet switch for communicating out-of-band SIP signals to the SIP-aware Access Port. Executable software for load balancing applications is provided. The management device monitors port traffic on the Ethernet switch, detects the presence of rogue access ports, monitors RF link quality, Access Port availability and quality of service indicators.

The present invention provides a set of application program interfaces embodied on a computer readable medium for execution on a computer in conjunction with an application program that manages a wireless network Access Port management device. These interfaces include a first interface that receives an input for establishing out-of-band communication with an Access Port, a second interface receives an input for establishing monitoring port traffic on an Ethernet switch and a third interface that receives an input from out-of-band aware applications associated with the Access Port. The out-of-bandwidth communication may be SIP communication protocol so that ports are SIP-aware Access Ports. Another interface may balance out-of-band communication aware applications over a plurality of Access Ports. A fifth interface may detect the presence of rogue access ports. A sixth interface may monitor for SIP-aware Access Port availability.

The method provides for managing SIP-aware applications on a wireless network using an Access Port management appliance associated with an Ethernet switch comprising identifying at least one SIP-aware Access Port in the wireless network to receive an SIP message, identifying an SIP-aware application associated with the at least one SIP-aware Access Port, and determining a route for Real-time Transport Protocol streams based the SIP-aware application associated with on the identified at least one SIP-aware Access Port.

### BRIEF DESCRIPTION OF THE FIGURES

Objects and features of the present invention will become apparent from the following detailed description considered in connection with the accompanying drawings disclosing embodiments of the present invention. It should be understood, however, that the drawings are designed for the purpose of illustration only and not as a definition of the limits of the invention. For a detailed understanding of the present invention, references should be made to the following detailed description of an exemplary embodiment, taken in conjunction with the accompanying drawings, in which like elements have been given like numerals in the drawings, wherein similar reference characters denote similar elements throughout the several views:

FIG. 1 illustrates a network for Access Ports with a switch and a network management device;

FIG. 2 illustrates a network for Thin Access Ports with a switch;

FIG. 3 illustrates a network for Thin Access Ports with a switch and a network management device;

FIG. 4 illustrates a network for Thin Access Ports with a switch and a network management device with out-of-band signaling;

FIG. 5 illustrates a network for SIP Aware Access Ports with a switch and a network management device associated with SIP Applications; and

FIG. 6 illustrates a flow chart representing data packet traffic on a network provided by the present invention.

While the invention will be described in connection with its preferred embodiments, it will be understood that the invention is not limited thereto. It is intended to cover all alternatives, modifications, and equivalents that may be included within the spirit and scope of the invention, as defined by the appended claims.

### DETAILED DESCRIPTION OF THE INVENTION

In view of the above, the present invention through one or more of its various aspects and/or embodiments is presented to provide one or more advantages, such as those noted below. The present invention provides for out-of-band signaling on a wireless LAN network supporting wireless Access Ports.

An Access Point, or Access Port, (AP) is a hardware device or a computer's software that acts as a communication hub for users of a wireless device to connect to a wired LAN. APs are important for providing heightened wireless security and for extending the physical range of wireless services.

In 802.11 a/b/g wireless Local Area Networks (LANs) there are two general types of Access Points/Ports. The first is classified as a “Thick” or intelligent Access Point, so called because the intelligence resides in the access point. The other is termed a “Thin” Access Port that receives all intelligence or management instructions directly from a Switch or a Wireless Local Area Network (WLAN) Appliance. There are at least four network architectures for providing APs.

The first architecture, the Standalone Thick Access Point is managed individually and not via any centralized switch or appliance. The Standalone Thick AP maintains all intelligence (and management functionality) locally at the AP which allows this standalone option. Traditional wireless LAN infrastructure deploys these intelligent thick wireless access points. Typically, these APs are attached directly to an existing wired Ethernet network to utilize a previously installed hardware base. The intelligence is in the access points, the work of maintaining, configuring and authentication, among other tasks, is executed at the access point. Each AP must be managed separately by a network administrator, which may be costly in a large wireless network.

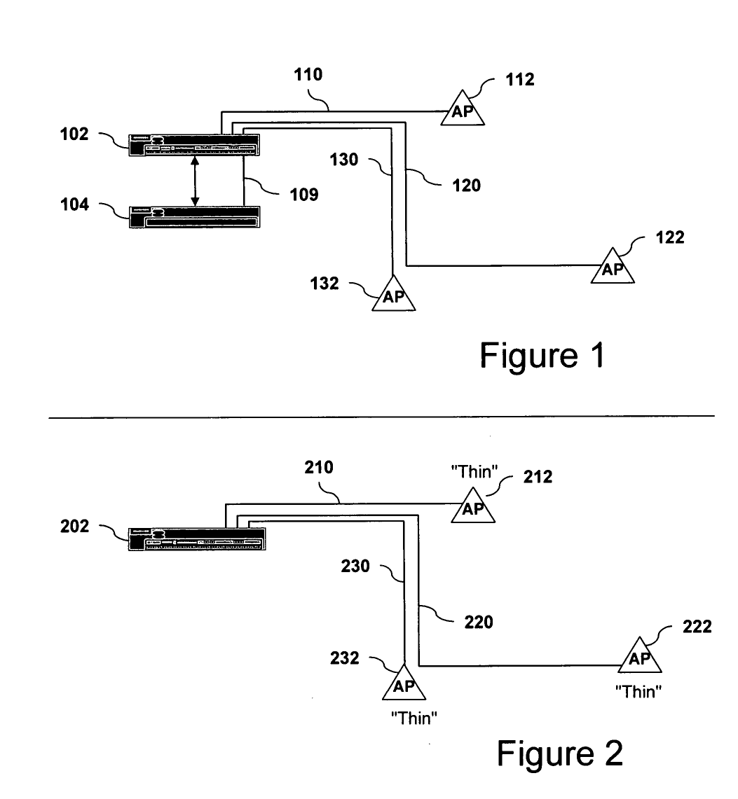

The second type of AP is the Centrally Managed “Thick” Access Point: An example of this is illustrated in FIG. 1 which includes a switch 102 and an AP management device or appliance 104 providing for a centralized, systems-level application for managing and controlling the wireless infrastructure. The device/application 104 may send commands across link 109 to the APs by way of links 110, 120 and 130 in conjunction with switch 102. Alternatively, the appliance 104 may send commands to Access Points 112, 122 and 132 directly. These same APs may be managed individually, but the hardwired device 104 can manage thousands of APs simultaneously.

As illustrated in the network of FIG. 2, a third type of AP is represented by examples of “Thin” Access Ports 212, 222 and 232 that may be tied via Ethernet 210, 220 and 230, respectively, directly to a Wireless Switch 202. The switch 202 can be used for traditional data connectivity to a computer or network, or it can be used to manage the APs. This architecture requires the APs 212, 222 and 232 to be tied directly via network cable (210, 220 and 230) to the switch 202. Once data from the Access Port is passed to the switch, the data are processed like any other packets.

For thin access ports such as 212, 222 and 232, the centralized management of the wireless switching involves a centrally controlled and managed wireless LAN switch 202 and “thin” access ports within an Ethernet foundation. As stated above, traditionally, access ports have been “thick” or intelligent wireless access points in an existing Ethernet network. All the intelligence has resided in and with the Access Ports (APs). In this approach, the intelligence is in the access points, and the work of managing the AP is performed within and/or at the AP. Each AP is a separate, standalone device, and is managed individually. In large wireless networks administration and management of these APs may be expensive.

In contrast, the “thin” approach comprises intelligence that is concentrated in a centralized Wireless Switch, such as 202 (or alternatively as illustrated with 104). Through a Wireless Switch 202, a network administrator can manage and control all wireless LAN functions, including the APs. The “thin” AP approach uses APs to centralize and integrate network intelligence and management functions in the wireless switch itself.

In addition to access, the centralized management wireless switch/appliance also provides an infrastructure for facilitating efficient network policies, network security and Quality of Service (QoS). By sharing the high-layer services provided with Ethernet switches, this approach delivers extensive wired LAN support, seamlessly integrating wireless traffic into a network. All APs and associated wireless applications may be subjected to the same authentication procedures as wired users/applications. Once connected to an Ethernet cable, the APs are automatically recognized and configured with appropriate settings.

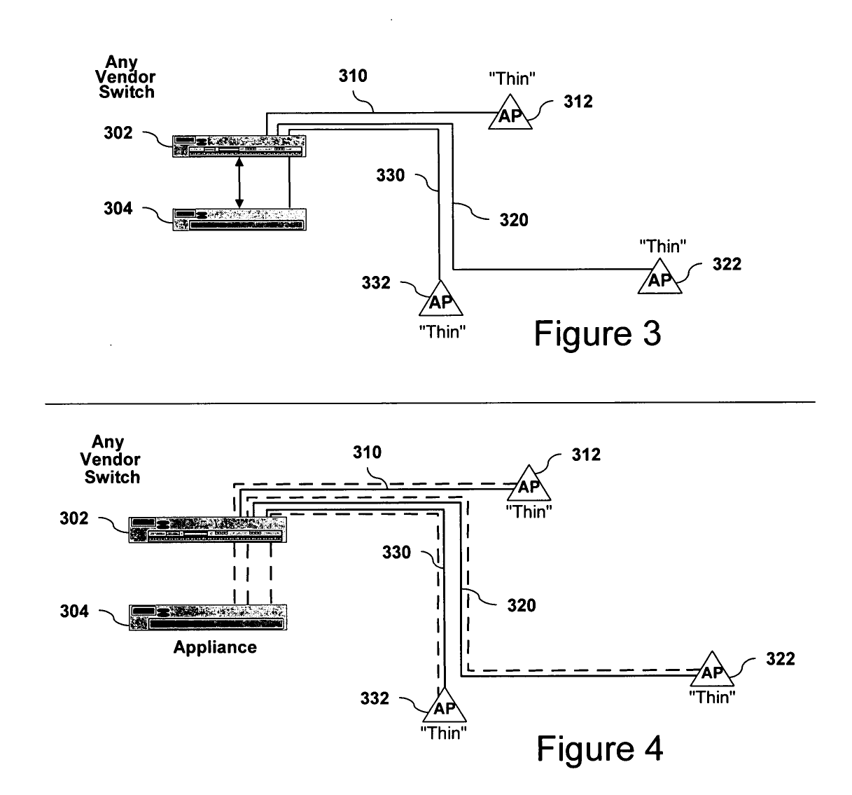

A fourth type AP architecture comprises “Thin” Access Ports tied to any Ethernet switch 302 with a Wireless Appliance 304 as illustrated in FIG. 3. This solution is appropriate where a customer may have existing Ethernet switches and would like to deploy a Wireless solution without replacing their current infrastructure. This architecture, for example, comprises a switch 302 and a management device 304. Connectivity facilitated by device 304 for the APs occurs for current switches. A difference between this architecture and the Centrally Managed “Thick” Access Point solution is that AP management information is passed to and through appliance 304. The Centrally Managed “Thick” Access Point only passes commands back and forth to a switch.

An embodiment of the present invention provides for an enhancement of the architecture for type four, the “Thin” APs tied to an Ethernet switch with a Wireless Appliance overlay. This arrangement is illustrated in FIG. 4. The present invention provides for all packets from the “Thin” Access Port to traverse an Ethernet switch 302 to device 304 or equivalents. However, all data may pass through the appliance 304. Because of this, the number of Access Port/Points supported by the Airspace switch may be limited by the bandwidth of the interface on the appliance/device 304 in conjunction with switch 302.

The method, system and apparatus of the present invention provide for a reduction in the wireless LAN bandwidth requirements and a significant increase in the numbers of Access Points or Access Ports that can be supported by the switch 304. An embodiment of the invention provides for “Out-of-Bandwidth” signaling between an AP and the wireless appliances like 304. Using signaling between the AP and the Wireless Appliance 304 allows for lower bandwidth requirements. The IP data packets will flow from the AP to the appliance 304 and then may be switched via normal networking methods. Any specific wireless commands and activities will be presented and communicated between APs and appliance 304 via the out-of-band signaling method.

The solid lines (310, 320 and 330) are the IP Data flow paths between the switch and the AP. The dashed lines that parallel the solid lines (310, 320 and 330) in FIG. 4 signify the out-of-band signaling between the AP and the appliance 304. No network “customer” data, for example Ethernet data, should need to pass the appliance 304. Management information passes between the Appliance 304 and the APs. This method of communications may rely on Layer 3 IP addressing at the APs (312, 322 and 332) and the Appliance 304. This allows IP communication between the devices. If it is desired that network traffic remain on the LAN and not cross a layer-3 routed network, the APs and Appliance 304 may communicate at layer 2 using MAC addresses. While this may limit some functionality, it also reduces communication costs.

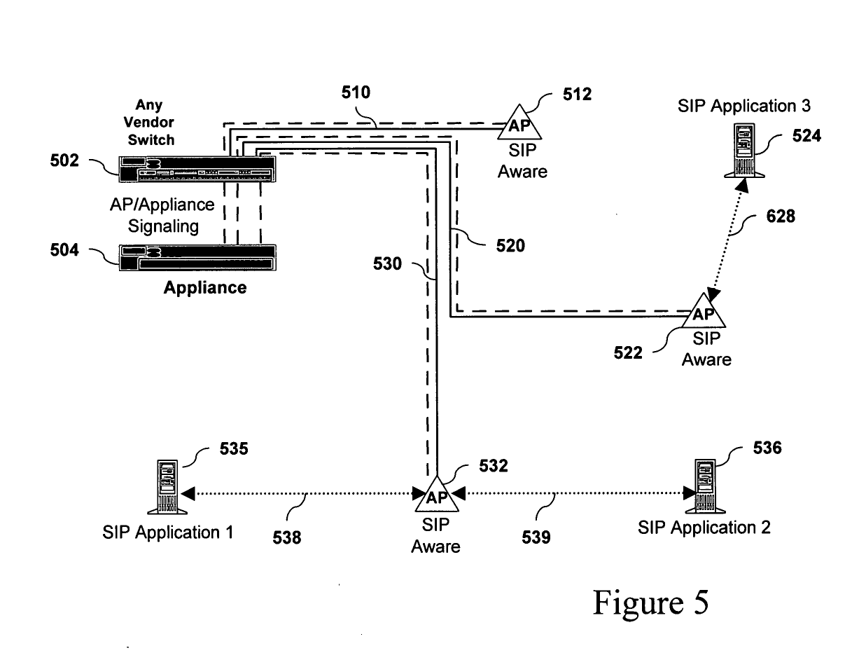

An embodiment of the present invention provides for leveraging a standard's based signaling protocol, for example Session Initiation Protocol (SIP) signaling to send messages to the Access Points from a Centralized Management location such as appliance 504 illustrated in FIG. 5. As illustrated in FIG. 5, SIP packets flow out-of-band (as differentiated from with IP Packet payload data) from appliance 504 to SIP Aware Wireless Access Points, such as 512, 522 and 532 as illustrated with the dashed lines in the FIG. 5 parallel with 510, 520 and 530.

The present invention provides for SIP messages between appliance 504 working in conjunction with switch 502, where the SIP message may include the following functionality:

1. AP ON/OFF—SIP Messages may be sent to switch on and off the RF interface of the Access Point.

2. AP Relay Content—An Access Point may act as a “Load Balancer SIP Redirector service.” In the past, content may have been load-balanced across a “wired” switch. With more and more applications becoming available via wireless applications there is an opportunity to load-balance across applications from the Access Point to multiple SIP aware applications. Examples are illustrated in FIG. 5.

By integrating SIP capabilities onto an Access Point other SIP devices may leverage the SIP “302” message to load-balance across multiple SIP Aware applications. (The SIP 302 message signifies that a messaging sequence is to be redirected.) This may be done via the RF (wireless) link. An example is a Call Center application to balance with a Call Control application (such as for IP PBX or Service Provider IP Telephony Solution applications).

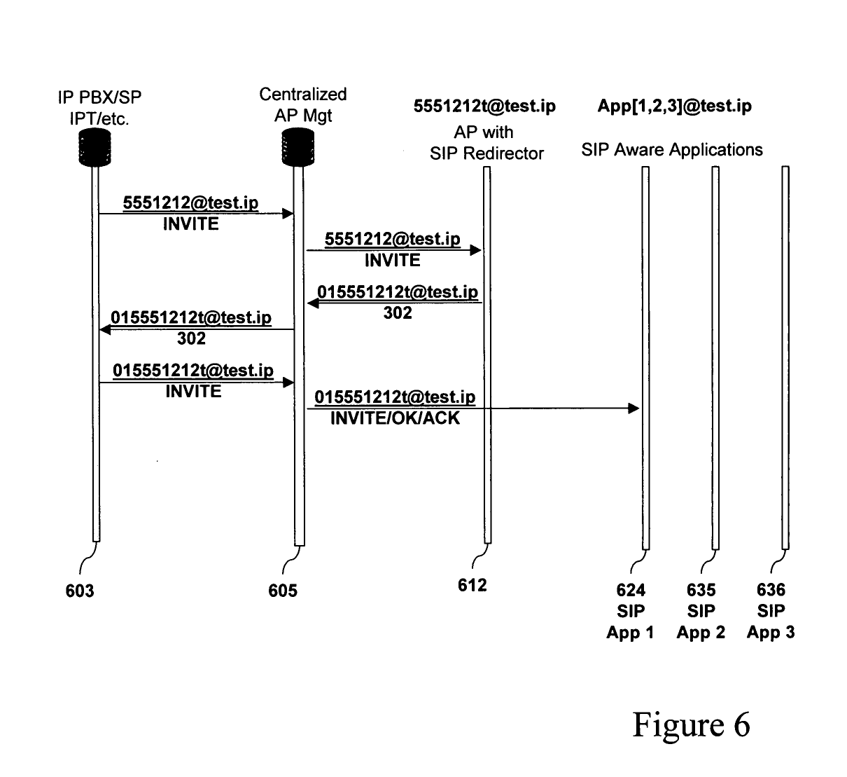

FIG. 6 illustrates a ladder diagram for an embodiment provided by the present invention:

1. A Load Balance SIP Aware application 624 is identified and is marked in the Centralized Management System 605 (this may be at 502, 504 or 502 in conjunction with 504). The Managing Application 603 (IP PBX, etc.) is also identified, as well as the other remote “balanced” applications.

2. An initial SIP Invite request (5551212@test.ip) is sent to the Centralized Management System 605 and from there to the Access Point 612.

3. The SIP Aware AP 612 identifies (as designated by the SIP Invite) which cluster of SIP Aware Application servers (624, 635 or 636) to send communications to and then sends a 302 Redirect message (015551212t@test.ip) back to the main application 603.

4. The 01 pre-pended to the SIP message header identifies which SIP-Aware Application to send the next SIP Message to.

5. The next SIP message from the Main Application 603 is directed at the SIP-Aware application (In this example “SIP Application 1” is associated with the SIP Invite Message 015551212t@test.ip.

6. Once the SIP messaging has completed the Real-time Transport Protocol (RTP) streams now flow directly from point to point.

The present invention provides for load balancing across multiple APs. Part of the load balancing scheme between multiple Access Points include various metrics such as availability, RF Link Quality, etc. Similar to the Single AP load-balancing method, multiple SIP Applications may be load-balanced across the Wireless network via the Centralized Management System appliance (504) together with switch 502. For example a Policy Enforcement option, using an SIP aware Access Point, other user SIP aware devices can be redirected to the Centralized Management System that provides specific policies enforcement for SIP aware devices. The intelligence for such a Policy Enforcement option, and other AP management options, may be embodied in software on the Centralized Management System appliance (504). An example is a Voice over Internet Protocol (VoIP) handset that may be attempting to register with the network. This solution provides front end authentication to either accept the device or reject it. Basic authentication may be handled via SIP messages.

Additionally, the present invention provides for “port spanning” on switch 502 to enable communicating management information via “In-Band” methods (i.e., so that management information is passed within the data payload). The appliance 504 may limit the amount of traffic traversing appliance 504 by working in partnership with the switch 502. The Ethernet Switch 502 works in conjunction with Wireless Appliance 504, providing a form of content analysis in the LAN. This provides a system and method for applying Wireless LAN management via analyzing and filtering a packet within this intelligent Ethernet Switch located within the customer's LAN.

The present invention provides a communications link between the Ethernet switch (502) and the WLAN Appliance (504). A network deployment of the WLAN appliance may be in a variety of locations, and appliance 504 may be deployed for central Management at a Managed Service Provider (MSP) location, whether on a customer's site, or on an Internet Service Provider's (ISPs) premises.

The method and apparatus of the present invention provides for greater wireless management capabilities per WLAN appliance. The invention provides for out-of-band signaling for use with or without an option for an Intelligent Ethernet Switch working in conjunction with the WLAN Appliance. With embodiments provided by the present invention, management of wireless infrastructure becomes easier and more cost effective.

The present invention provides a method, system and apparatus for managing wireless network Access Ports. The invention provides a computer readable medium containing instructions that when executed by a computer perform a computerized method for managing out-of-bandwidth aware applications on a wireless network using an Access Port management appliance associated with an Ethernet switch. Out of bandwidth communications may use SIP communication protocol. At least one SIP-aware Access Port and at least one SIP-aware application are identified in the wireless network to receive an SIP message. A route is then determined for Real-time Transport Protocol streams. The Access Port management appliance monitors the SIP-aware application and may perform load balancing over one or a plurality of Access Ports. Monitoring Access Ports includes measuring availability, RF link quality and Quality of Service indicators. Authentication for applications and devices to a network may be via SIP or other out-of-bandwidth messages, and intrusion detection of rogue access ports is also provided.

The present invention provides a system for managing a wireless network comprising an Ethernet switch, an SIP-aware application, an SIP-aware Access Port and an SIP-aware Access Port management device associated with the Ethernet switch for communicating out-of-band SIP signals to the SIP-aware Access Port. Executable software for load balancing applications is provided. The management device monitors port traffic on the Ethernet switch, detects the presence of rogue access ports, monitors RF link quality, Access Port availability and quality of service indicators.

The present invention provides a set of application program interfaces embodied on a computer readable medium for execution on a computer in conjunction with an application program that manages a wireless network Access Port management device. These interfaces include a first interface that receives an input for establishing out-of-band communication with an Access Port; a second interface receives an input for establishing monitoring port traffic on an Ethernet switch and a third interface that receives an input from out-of-band aware applications associated with the Access Port. The out-of-bandwidth communication may be SIP communication protocol so that ports are SIP-aware Access Ports. Another interface may balance out-of-band communication aware applications over a plurality of Access Ports. A fifth interface may detect the presence of rogue access ports. A sixth interface may monitor for SIP-aware Access Port availability.

Accordingly, while embodiments of the present invention have been shown and described, it is to be understood that many changes and modifications may be made thereunto without departing from the spirit and scope of the invention as defined in the appended claims.

The present invention described herein is well adapted to carry out the objects and attain the ends and advantages mentioned, as well as others inherent therein. While various embodiments of the invention have been given for purposes of disclosure, numerous changes exist in the details of procedures for accomplishing the desired results. Various modifications will be apparent to those skilled in the art. It is intended that all variations within the scope and spirit of the appended claims be embraced by the foregoing disclosure.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A computer readable medium containing instructions that when executed by a computer perform a computerized method for managing SIP-aware applications on a wireless network using an Access Port management appliance associated with an Ethernet switch comprising:
(a) identifying at least one SIP-aware Access Port in the wireless network to receive an SIP message;
(b) identifying an SIP-aware application associated with the at least one SIP-aware Access Port; and
(c) determining a route for Real-time Transport Protocol streams based the SIP-aware application associated with on the identified at least one SIP-aware Access Port.

2. The medium of claim 1 further comprising monitoring the SIP-aware application with the Access Port management appliance associated with the Ethernet switch.

3. The medium of claim 1 wherein a plurality of SIP-aware applications are load-balanced over a plurality of Access Ports.

4. The medium of claim 1 wherein the SIP-aware application is load-balanced across a plurality of Access Ports.

5. The medium of claim 1 further comprising monitoring the at least one Access Port to obtain measurements at least one of the group consisting of i) availability, ii) RF link quality and iii) Quality of Service.

6. The medium of claim 1 wherein the SIP-aware application is authenticated to the network via SIP messages.

7. The medium of claim 2 wherein monitoring the SIP-aware application with the Access Port management appliance associated with the Ethernet switch further comprises:
intrusion detection of a rogue access port.

8. The medium of claim 1 wherein an SIP-aware device is authenticated to the network via SIP messages.

9. A system for managing a wireless network comprising:
(a) an Ethernet switch;
(b) an SIP-aware application;
(c) an SIP-aware Access Port; and
(d) an SIP-aware Access Port management device associated with the Ethernet switch for communicating out-of-band SIP signals to the SIP-aware Access Port.

10. The system of claim 9 wherein the management device further comprises executable software for load balancing SIP-aware applications.

11. The system of claim 9 wherein the management device further comprises a port for monitoring all traffic across all ports.

12. The system of claim 9 wherein the SIP-aware Access Port is a Thin Access Port.

13. The system of claim 9 wherein the management device further comprises a program for detection of rogue access ports.

14. The system of claim 9 wherein the management device further comprises a program for monitoring RF link quality.

15. The system of claim 9 wherein the management device further comprises a program for monitoring SIP-aware Access Port availability.

16. A set of application program interfaces embodied on a computer readable medium for execution on a computer in conjunction with an application program that manages a wireless network Access Port management device, comprising:
(a) a first interface that receives an input for establishing out-of-band communication with an Access Port;
(b) a second interface receives an input for establishing monitoring port traffic on an Ethernet switch; and
(c) a third interface that receives an input from out-of-band aware applications associated with the Access Port.

17. The set of application program interfaces of claim 16 wherein the out-of-band communication is SIP communication.

18. The set of application program interfaces of claim 16 further comprising: a fourth interface balancing out-of-band communication aware applications over a plurality of Access Ports.

19. The set of application program interfaces of claim 16 further comprising: a fifth interface for detection of rogue access ports.

20. The set of application program interfaces of claim 16 further comprising: a sixth interface for monitoring SIP-aware Access Port availability.
